(19) United States
(12) Patent Application Publication
(10) Pub. No.: US 2017/0192735 A1
(43) Pub. Date: Jul. 6, 2017

(54) SYSTEM AND METHOD FOR SYNCHRONIZED DISPLAYS

(71) Applicant: CallVU Ltd., TEL AVIV (IL)

(72) Inventors: Ori FARAN, Modiin (IL); Doron ROTSZTEIN, Netanya (IL)

(73) Assignee: CallVU Ltd., TEL AVIV (IL)

(21) Appl. No.: 15/394,200

(22) Filed: Dec. 29, 2016

Related U.S. Application Data
(60) Provisional application No. 62/273,800, filed on Dec. 31, 2015.

(51) Int. Cl. G06F 3/14; H04M 3/51; H04L 29/06

(52) U.S. Cl. CPC G06F 3/1454; H04L 65/1069; H04L 65/403; H04M 3/5183; H04L 65/4007

(57) ABSTRACT

A synchronized display server and a method for providing synchronized displays. The synchronized display server includes a processing circuity; and a memory, the memory containing instructions that configure the synchronized display server to: establish a first data session with a user device and a second data session with a contact center representative device; obtain display data to be displayed on the user device, wherein the display data is communicated over the second data session; obtain communication data related to communications between the user device and a contact center associated with the contact center representative device, wherein the display data is communicated over the first data session; generate, based on the obtained display data and communication data, a synchronized display; and send, via the first data session and the second data session, wherein each of the user device and the contact center representative device displays the sent synchronized display.

### CROSS-REFERENCE TO RELATED APPLICATIONS

This application claims the benefit of U.S. Provisional Patent Application No. 62/273,800 filed on Dec. 31, 2015, the contents of which are hereby incorporated by reference for all that they contain.

### TECHNICAL FIELD

The present disclosure relates generally to call centers, and more particularly to enabling hybrid displays for communications with call centers.

### BACKGROUND

One of the challenges facing companies, organizations, and enterprises today is to present their customers with access to information without exploiting their resources. With this aim, call center systems have been utilized to communicate with customers. A call center is a centralized office used for the purpose of receiving and transmitting a large volume of requests. Typically, call centers are based on interactive voice response (IVR) systems that provide information and/or call routing by leading a user through a series of menu-driven voice prompts. Call centers also typically utilize customer service representatives (CSRs) when customers wish to speak to a live person.

Other means to serve requests from customers are web sites that can be accessed through personal computers (PCs) or mobile devices. However, customers often choose to call the company for service with the intent of talking to an agent or interacting with the company via phone.

CSRs, sometimes referred to as “agents” or collectively as the “human channel” of an entity, mainly communicate with customers via telephone calls, textual communications, or both. CSRs are trained to address various customer requests, and may operate desktop systems such as computerized Customer Relation Management (CRM) systems to track customer information and to access information and action systems. Customers often prefer communicating with CSRs over communicating with digital self-service channels provided via, for example, web pages or mobile applications, due to the more natural communications associated with speaking to a person, as well as the added flexibility in providing answers and advice offered by a human representative in real-time.

While the benefits offered by communicating with a CSR may make communicating with call centers an attractive option for handling customer requests, these communications typically lack several robust tools, such as visual depictions of content, that may be available through digital channels such as web and mobile applications. Further, CSRs of the human channel are typically unable to oversee user progress via the digital channel. For example, a CSR typically cannot see the display presented to a user viewing a menu on a mobile application. Further, existing solutions allowing a CSR to view digital channel information displayed on a user's device typically require establishing a connection between the CSR's device and the user's device. This connection may be inconvenient, is less secure, and may hinder resolution of the user's request for assistance (e.g., when the display on the CSR's device does not match the display on the user's device due to lag between display on the user's device and display on the CSR's device).

Additionally, companies seek continuous improvement on the channel's performance on measurements such as average handling time (AHT), first contact resolution (FCR), and customer satisfaction. Improvements to these performance measurements are highly desirable, and may translate to increased sales of products and services. Providing CSRs with additional information related to the user's request and progress may be beneficial to improving these performance measurements.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a synchronized display server, comprising: a processing circuity; and a memory communicatively connected to the processing circuitry, the memory containing instructions that, when executed by the processing circuity, configure the synchronized display server to: establish a first data session with a user device and a second data session with a contact center representative device; obtain, from the contact center representative device, display data to be displayed on the user device, wherein the display data is communicated over the second data session; obtain, from the user device, communication data related to communications between the user device and a contact center associated with the contact center representative device, wherein the display data is communicated over the first data session; generate, based on the obtained display data and communication data, a synchronized display; and send, via the first data session and the second data session, the synchronized data to the user device and to the contact center representative device, respectively, wherein each of the user device and the contact center representative device displays the sent synchronized display.

Certain embodiments disclosed herein also include a non-transitory computer readable medium having stored thereon instructions for causing one or more processing units to execute a method, the method comprising: establishing a first data session with a user device and a second data session with a contact center representative device; obtaining, from the contact center representative device, display data to be displayed on the user device, wherein the display data is communicated over the second data session; obtaining, from the user device, communication data related to communications between the user device and a contact center associated with the contact center representative device, wherein the display data is communicated over the first data session; generating, based on the obtained display data and communication data, a synchronized display; and sending, via the first data session and the second data session, the synchronized data to the user device and to the contact center representative device, respectively, wherein each of the user device and the contact center representative device displays the sent synchronized display.

Certain embodiments disclosed herein also include a method for providing synchronized displays, comprising: establishing a first data session with a user device and a second data session with a contact center representative device; obtaining, from the contact center representative device, display data to be displayed on the user device, wherein the display data is communicated over the second data session; obtaining, from the user device, communication data related to communications between the user device and a contact center associated with the contact center representative device, wherein the display data is communicated over the first data session; generating, based on the obtained display data and communication data, a synchronized display; and sending, via the first data session and the second data session, the synchronized data to the user device and to the contact center representative device, respectively, wherein each of the user device and the contact center representative device displays the sent synchronized display.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is an illustration of a graphical display inviting a client to initiation a collaboration session.

FIG. 3 is an illustration of a graphical display including a graphical demonstration and explanation based on generic and personal data.

FIG. 4 is an illustration of a graphical display of information, notes, and reminders available on a user device.

FIG. 5 is an illustration of a graphical display of information, notes, and reminders available on a user device via a call-for-action.

FIG. 6 is an illustration of a graphical request for input in the form of a call-for-action.

FIG. 7 is an illustration of a graphical checklist.

FIG. 8 is a block diagram of a synchronized display server according to an embodiment.

FIG. 9 is a flowchart illustrating a method for providing synchronized displays according to an embodiment.

FIG. 10 is a flow diagram illustrating the operation of the synchronized display server according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The embodiments disclosed herein include systems and methods for providing synchronized displays. Some embodiments disclosed herein include a synchronized display server for communicating synchronized displays and inputs related to synchronized displays between a contact center and customer digital channels (CDC). In an embodiment, the synchronized display system is realized using a synchronized display server, a contact center, and a synchronized display agent installed on a user device.

The contact center communicates with the synchronized display server to at least receive data related to synchronized displays displayed on the user device and to send directions for modifying synchronized displays to be displayed on the user device. The synchronized display agent is configured to cause displays of synchronized displays received from the synchronized display server and to send, to the synchronized display server, user interaction data indicating user inputs with synchronized displays displayed via the user device. The synchronized display system allows for providing information displayed on a user device via a digital communication channel to a contact center representative device, thereby providing a hybrid self-assistance tool incorporating visual interactive content into contact center communications.

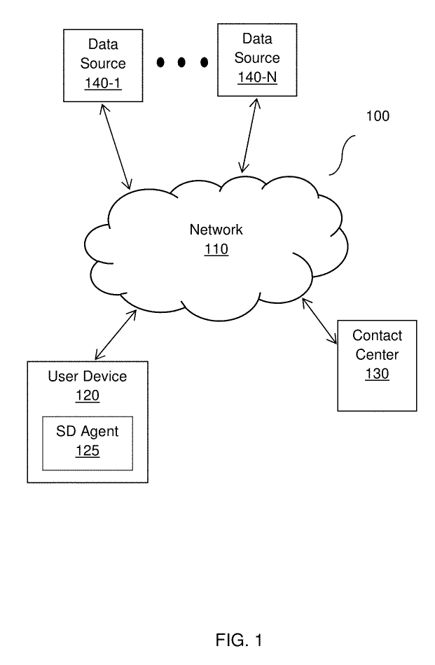

FIG. 1 shows an example network diagram 100 utilized to describe the various disclosed embodiments. The network diagram 100 includes a network 110, a user device 120, a contact center 130, and a plurality of data sources 140-1 through 140-N (hereinafter referred to individual as a data source 140 and collectively as data sources 140, merely for simplicity purposes). Integration of the contact center 130 may include an interface or a group of interfaces, utilizing one or more background application programming interfaces (not shown), or both.

The network 110 may be, but is not limited to, a wireless, cellular, or wired network, a local area network (LAN), a wide area network (WAN), a metro area network (MAN), the Internet, the worldwide web (WWW), similar networks, and any combination thereof. The components of the network diagram 100 may be communicatively connected via the network 110.

The contact center 130 may be, but is not limited to, a call center or other system for establishing communications between contact center representatives (CCRs) and a user of the user device 120. Each CCR may utilize a CCR device, which may be, but is not limited to, a personal computer, a laptop, a tablet computer, a smartphone, a wearable computing device, and the like. The CCR device may be configured for telephone calls or other communications.

The contact center 130 may include or be communicatively connected to a database (not shown). The database 130 may include user interaction data and analytics as well as parameters related to the user device 140. The synchronized display server 150 is configured to provide synchronized displays to the contact center 130 and, in an embodiment, to CCR devices (not shown) of the contact center 130.

Alternatively or collectively, the contact center 130 may be communicatively connected to the data sources 140, which may include data related to, e.g., the user of the user device 120, the user device 120, past contact center sessions with the user of the user device 120, and the like. Each of the data sources 140 may be, but is not limited to, a consumer rights management (CRM) system, an interactive voice response (IVR) system, a web server, and the like. The data sources 140 may be accessed to retrieve data related to, for example, customer interactions, interactive voice response menus and prompts, and the like. The contact center 130 may utilize one or more APIs (not shown) for accessing the data sources 140.

The contact center 130 may include an interactive display server (not shown). The interactive display server is configured to implement a unified display response via the user device 120 and, in particular, via the synchronized display (SD) agent 125. An example interactive display server which may be utilized by the contact center 130 is described in U.S. Pat. No. 8,340,255, assigned to the common assignee, which is hereby incorporated by reference.

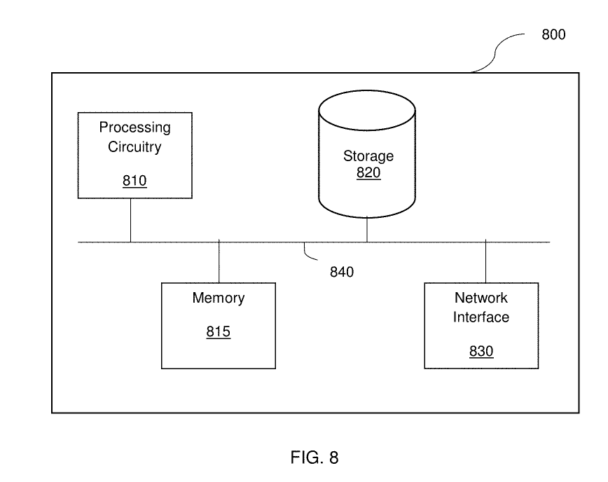

The contact center 130 is configured to enable synchronized displays of content to the user device 120 and to one or more CCR devices. To this end, the contact center 130 further includes a synchronized display server (e.g., the synchronized display server 800, FIG. 8). The synchronized display server is described further herein below.

The user device 120 may be, but is not limited to, a personal computer, a laptop, a tablet computer, a smartphone, a wearable computing device, or any other device equipped with web browsing and communications capabilities. The user device 120 may be installed with a synchronized display agent 145. The synchronized display agent 145 may be, but is not limited to, a mobile application, a virtual application, a web application, a native application, and the like. In an embodiment, the synchronized display agent 125 is configured to cause communications with the contact center 130 over the network 110, and to cause displays of digital communication channel information on the user device 120.

In an embodiment, the synchronized display agent 125 may be further configured to identify parameters related to the user device 120 and to cause storage of the identified parameters in the data sources 140. The parameters may include, but are not limited to, global positioning signals, network connections, and so on. The contact center 130 may utilize the identified parameters to determine, for example, a location of the user device 120, thereby allowing for customization of synchronized displays based on the location of the user of the user device 120. As a non-limiting example, display features such as colors, arrangement of information, default language, and the like, may differ depending on the location of the user device 120.

In an embodiment, the contact center 130 is configured to communicate with the user device 120 via the network 110. The connection may be secured and may handle data formatting, validation, and compression. The contact center 130 may further utilize a health-check API to monitor its availability status.

In another embodiment, the contact center 130 is also configured to communicate using external notification mechanisms (not shown) such as, but not limited to, short message service (SMS) gateways, Apple® Push Notification Service (APNS), and Google® Cloud Messaging (GCM) through the network 110. The connection may be secured and handle data formatting, validation, and compression. In an embodiment, the contact center 130 may be configured to cause display of a synchronized display on the user device 120 via the external notification mechanisms in response to, e.g., directions received from a CCR device. Alternatively, the contact center 130 may be configured to send the synchronized display to the user device 120, and the synchronized display may be caused manually by a user (via, e.g., the user device 120).

In an embodiment, the contact center 130 is configured to generate the synchronized displays to be sent for display on the user device 120. To this end, in an embodiment, the contact center 130 includes a synchronized display server (e.g., via the synchronized display server 800, FIG. 8). In a further embodiment, the synchronized displays may be generated based on data obtained from a CCR device, the data sources 140, the synchronized display agent 125, or a combination thereof. In yet a further embodiment, the synchronized displays are generated based on information related to user interactions with interactive displays shown on the user device 120 and to communications of the user device 120 with the contact center 130.

In another embodiment, the user device 120 may establish a data session with the contact center 130 to receive interactive display services. After establishing the data session, the user device 120 may further initiate a call or other communication with the contact center 130. The contact center 130 may be configured to store data related to pre-call interactive display interactions in, e.g., the data sources 140 for subsequent use by the contact center representative using the CCR device. Allowing the CCR device to access pre-call information allows for increased continuity between communications with the contact center 130 and the synchronized displays displayed on the user device 120.

Communications among the components of the network diagram 100 will now be discussed in more detail. Data sessions between the user device 120 and the contact center 130 may be triggered by a caller (e.g., via a call made using the user device 120) or by a CCR device (e.g., either automatically or based on inputs from a contact center representative using the CCR device). The data sessions between the user device 120 and the contact center 130 may be utilized to transfer data including, but not limited to, synchronized displays to be displayed on the user device 120, user inputs related to interactive displays, or both.

In an embodiment, the synchronized displays sent to the user device 120 are also provided to the CCR device of a contact center representative overseeing a user's session with the call center 130. In a further embodiment, the synchronized displays are simultaneously displayed on both the user device 120 and a CCR device, thereby allowing the contact center representative to view the display that is currently displayed to the user.

In an embodiment, the synchronized displays are generated based on content to be displayed on the user device 120 that is obtained from, e.g., a CCR device. The content to be displayed may include, but is not limited to, menus, prompts, graphs, combinations thereof, and the like. In a further embodiment, the synchronized displays may be generated further based on data related to communications between the user device 120 and the contact center 130. Such data may be obtained from, e.g., the user device 120 (e.g., received from the user device 120 or retrieved from a storage of the user device 120).

On a session that is triggered by the caller via the user device 120, the synchronized display agent 125 will send an update request to the call center 130, and the call center 130 will transfer the call to a CCR device for review by a representative, to a queue for holding until a representative is available, or to an automatic handling system (not shown).

In an embodiment, initiation of a session with the user device 120 may require generation of a decoded string and a unique code. The contact center 130 may cause the string and code generation, and may store the generated string and code in, e.g., a database (not shown). In a further embodiment, all requests from the user device 120 to a backend server (not shown) are received using the code.

In an embodiment, each component of the network diagram 100 may utilize a health-check API. The health-check APIs may be utilized for, e.g., controlling availability of the components.

In an embodiment, any of the interactions between the user device 120 and the call center 130 may be based on unique tokens. Each unique token may be generated, e.g., per session. Each interaction may further be registered and stored in the database 130 along with its respective unique session token. Additional parameters may also be stored in the database respective of the interaction. Such parameters may include, but are not limited to, a phone number of the user device 120, a registration code, and so on.

In another embodiment, interaction with the user device 120 may require registration. In a further embodiment, each of the contact center 130 and the user device 120 may generate a public key, and the generated keys may be exchanged. All traffic between the contact center 130 and the user device 120 may be encrypted using the exchanged keys. In another embodiment, if the user device 120 is not registered, a single use code may be generated and provided to the user (via, for example, a voice session with the user device 120 or a display caused via the synchronized display agent 125). The code may be generated by the contact center 130 or by the user device 120. The user using the user device 120 may be prompted to enter the single use code before beginning a session in which synchronized displays would be displayed on the user device 120.

It should be noted that the embodiments disclosed herein are described with respect to a single user device 120 and a single network 110 merely for simplicity purposes and without limitations on the disclosure. Multiple user devices may be communicatively connected via the network 110, and multiple networks may be utilized to communicate among the components of the network diagram 100, without departing from the scope of the disclosure.

Additionally, the contact center 130 is described as including a single interactive display server merely for simplicity purposes and without limitation on the disclosed embodiments. Multiple interactive display servers may be distributed between components of the network diagram, within the contact center 130, or both, without departing from the scope of the disclosure. Alternatively, an interactive display server may reside in a distributed multi-layer environment, where each instance of the interactive display server can serve different types of elements, thereby exposing different sets of APIs.

It should further be noted that the contact center 130 may include multiple physical machines, with each physical machine including stateless modules having the same type. As an example, any or all of the CCR device, the IDS, and the synchronized display server may include a first physical machine for serving internal requests and a second physical machine for serving external requests. It should also be noted that the components of the contact center 130 may be in different geographical locations without departing from the scope of the disclosure.

It should also be noted that the synchronized display server is described herein as included in the contact center 130 merely as an example and without limitation on the disclosed embodiments. The synchronized display server may be separate from and communicatively connected to the contact center 130 without departing from the scope of the disclosure.

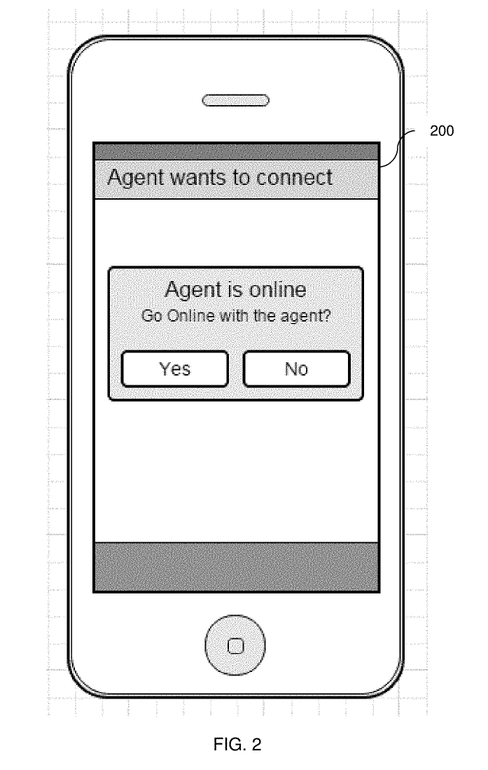

FIGS. 2 through 7 are example graphical displays 200 through 700, respectively. In an example embodiment, the example graphical displays 200 through 700 may be displayed on a user device (e.g., the user device 120). Display of the graphical displays 200 through 700 may be caused by an agent (e.g., the synchronized display agent 125) installed on the user device.

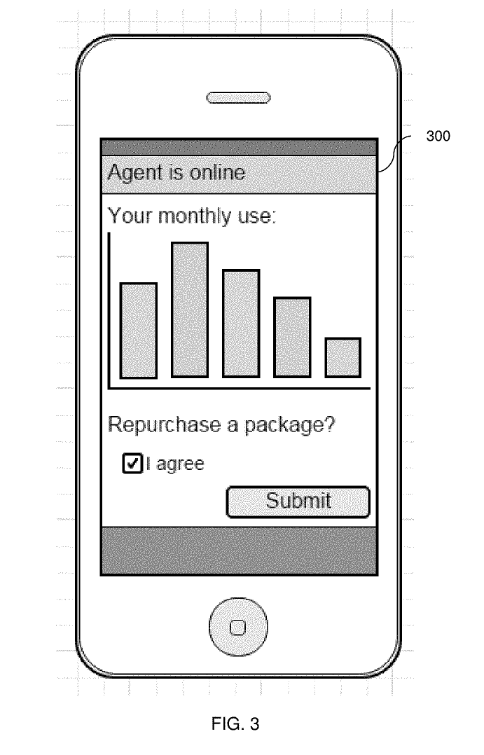

FIG. 2 illustrates a graphical display 200 including a message sent by to a user to prompt the caller to initiate a visual collaboration session. The message may be sent by a call center (e.g., the call center 130) seeking to provide synchronized displays between the user device and a CCR device. FIG. 3 illustrates a graphical display 300 including a message sent to a caller to provide a visual demonstration and explanation, using generic data (i.e., data that is related to users generally or otherwise not particular to the user), personal data (i.e., data that is specific to the user), or both, to make an offer and to receive feedback.

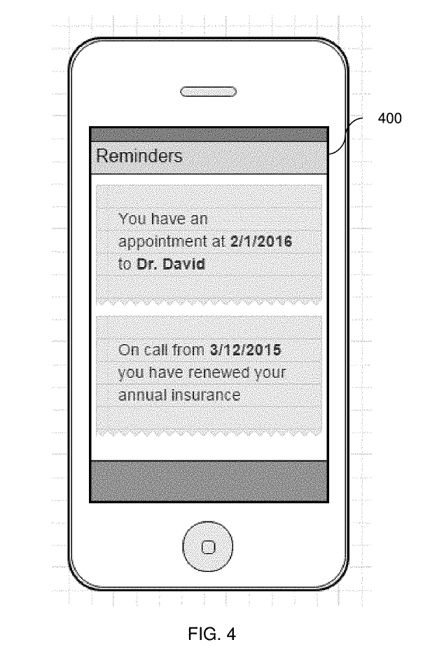

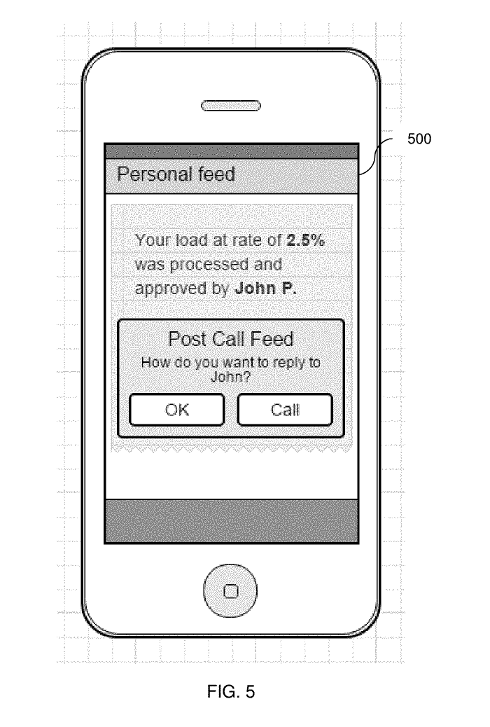

FIG. 4 illustrates a graphical display 400 including graphical information, notes, or reminders available on a user device (e.g., the user device 140). FIG. 5 illustrates a graphical display 500 including graphical information, notes, or reminders pushed to a user device in the form of a call-for-action. The content may be displayed, e.g., during a call or as a follow up after a call, automatically or by the contact center 130.

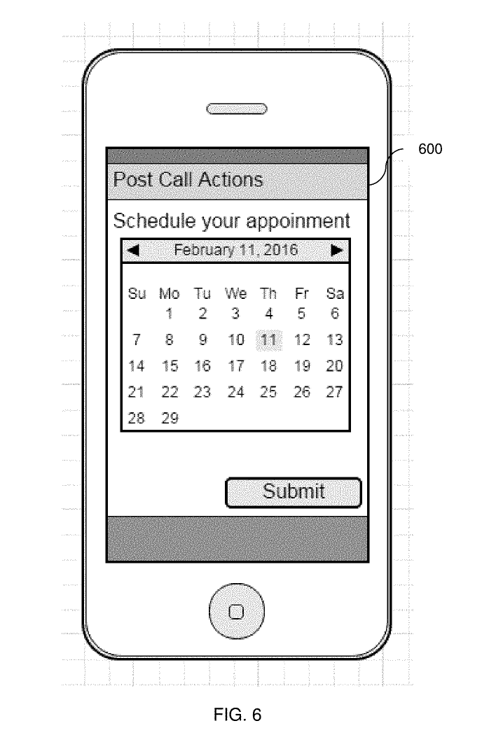

FIG. 6 illustrates a graphical display 600 including a request for an input in the form of a call-for-action which is generally available or pushed to the customer's device according to a call's context. In the graphical display 600, the call to action prompts the user to select a date for an appointment.

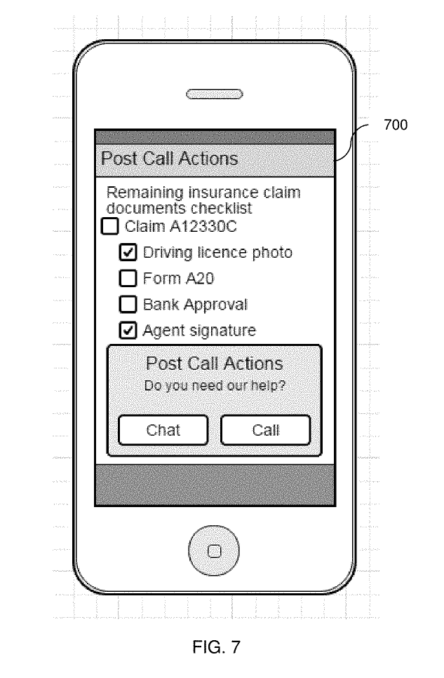

FIG. 7 illustrates a graphical display 700 of a check-list. The content may be generally available or pushed to the user device according to a call's context. Actions by users of the user device may be communicated back to the contact center for automatic or manual processing.

FIG. 8 is an example block diagram of a synchronized display (SD) server 800 according to an embodiment. In an embodiment, the synchronized display server 800 includes a processing circuitry 810 coupled to a memory 815, a storage 820, and a network interface 830. In an embodiment, the components of the synchronized display server 800 may be communicatively connected via a bus 840.

The processing circuitry 810 may be realized as one or more hardware logic components and circuits. For example, and without limitation, illustrative types of hardware logic components that can be used include field programmable gate arrays (FPGAs), application-specific integrated circuits (ASICs), system-on-a-chip systems (SOCs), general-purpose microprocessors, microcontrollers, digital signal processors (DSPs), and the like, or any other hardware logic components that can perform calculations or other manipulations of information.

The memory 815 may be volatile (e.g., RAM, etc.), non-volatile (e.g., ROM, flash memory, etc.), or a combination thereof. In one configuration, computer readable instructions to implement one or more embodiments disclosed herein may be stored in the storage 820.

In another embodiment, the memory 815 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 810 to perform the various processes described herein. Specifically, the instructions, when executed, cause the processing circuitry 810 to provide synchronized displays, as discussed herein.

The storage 820 may be magnetic storage, optical storage, and the like, and may be realized, for example, as flash memory or other memory technology, CD-ROM, Digital Versatile Disks (DVDs), or any other medium which can be used to store the desired information.

The network interface 830 allows the synchronized display server 800 to communicate with components of the contact center 130 such as, but not limited to, contact center representative devices, databases, interactive display servers, and the like. The network interface 830 may also allow the synchronized display server 800 to communicate with, e.g., the user device 120 (e.g., to provide synchronized displays to the user device 120). The communication may be facilitated over a network (e.g., the network 120, FIG. 1).

It should be understood that the embodiments described herein are not limited to the specific architecture illustrated in FIG. 8, and other architectures may be equally used without departing from the scope of the disclosed embodiments.

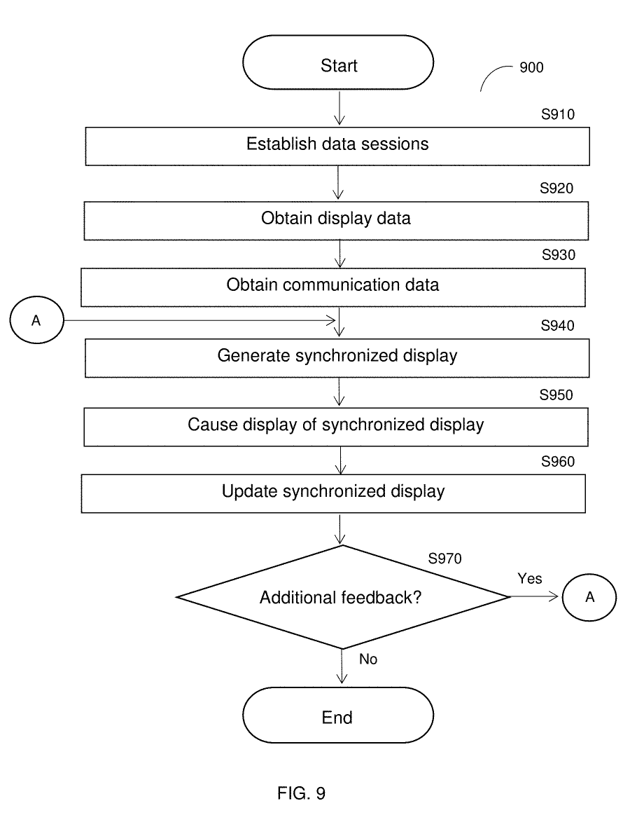

FIG. 9 is an example flowchart 900 illustrating a method for providing synchronized displays according to an embodiment. In an embodiment, the method may be performed by a synchronized display server (e.g., the synchronized display server 800, FIG. 8). In another embodiment, the method may be performed in response to a request from, but not limited to, a synchronized display agent (e.g., the synchronized display agent 125, FIG. 1), a contact center representative device (e.g., a CCR device of the contact center 130, FIG. 1), and the like.

At S910, a data session is established with a user device (by means of the synchronized display agent 125, FIG. 1) and with a contact center representative device. Each data session is bidirectional. That is, a data session with the contact center representative device may be utilized for, e.g., receiving data to be displayed on the user device and sending synchronized displays to be displayed on the contact center representative device. The data session with the user device may be utilized for, e.g., causing displays of synchronized displays on the user device as well as for obtaining data related to communications between the user device and a contact center.

In an embodiment, the data session between the synchronized display server and the user device may be established prior to establishing the data session between the synchronized display server and the contact center representative device. Such an order of establishment may be utilized when, for example, a contact center representative using a CCR device is not initially available or when a user of the user device initially seeks information only via interactive displays but subsequently decides to contact a representative (e.g., either dialing in to a call center or being prompted to connect to a contact center representative as seen in, for example, FIG. 2). Thus, the data session may be established once a contact center representative is available to oversee the data session with the user device by viewing synchronized displays of the information displayed on the user device.

At optional S920, data to be displayed on the user device is obtained over the active data session with the contact center representative device. The data may be based on, but not limited to, inputs from the contact center representative device, data stored in one or more data sources (e.g., the data sources 160) accessible to the contact center representative device, a location of the user device, a combination thereof, and the like. The display data is selected by the contact center representative and pushed or sent from the contact center to the user the device. This is performed as long as there is an active session data between the user device and the contact center.

At S930, communication data related to communications between the user device and a contact center associated with the contact center representative device is obtained via the data session with the user device. The communication data may include feedback provided by a user of the user device, personal information related to the user, and so on.

At S940, a synchronized display is generated based on the obtained display data, the obtained communication data, or both. The synchronized display incorporates information related to user communications with the contact center and with interactive displays displayed on the user device. Accordingly, the synchronized display provides continuity between, e.g., telephonic or other contact center communications and interactive display communications. For example, the synchronized display may include a form generated in response to the user's personal data. The form may be a call-to-action form including the user selection.

At S950, a display of the generated synchronized display is caused on the user device and on the CCR device. In an embodiment, S950 includes sending the synchronized display to the user device and to the CCR device.

At optional S960, the synchronized display is updated. In an embodiment, S960 further includes obtaining feedback data from the user device, generating an updated interactive display based on the obtained feedback data, and causing a display of the updated synchronized display. The feedback may be based on, but not limited to, user inputs (e.g., user interactions with the synchronized display). Thus, as the user makes selections or otherwise provides inputs that prompt changes in the information displayed to the user, synchronized displays are generated and sent to both the user device and to the CCR device of the contact center representative overseeing the session.

At S970, it is determined if additional feedback data has been received and, if so, execution continues with S940; otherwise, execution terminates. Checking for additional feedback allows for updating the synchronized display in real-time, thereby ensuring continuity between the synchronized display and the most recent user communications.

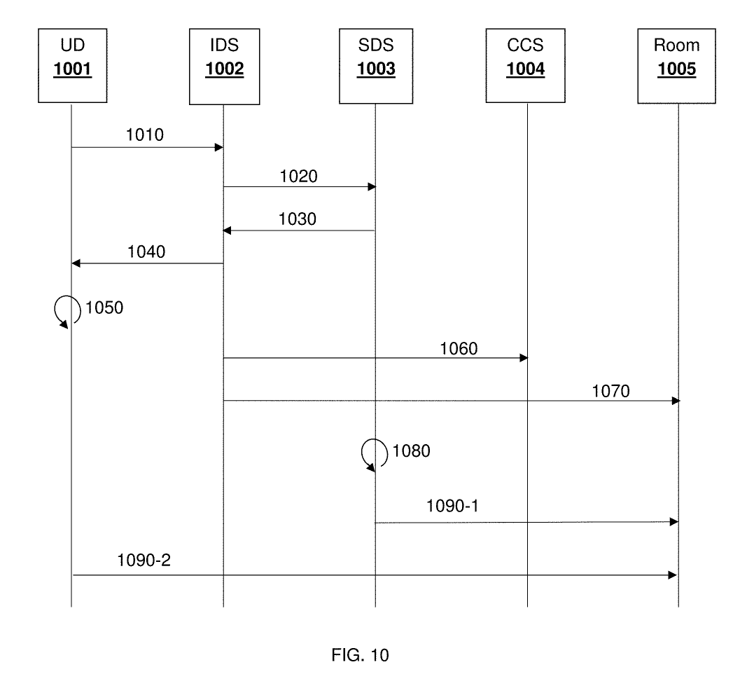

FIG. 10 is an example flow diagram 1000 illustrating providing synchronized displays to a user device (UD) 1001 and a contact center service (CCS) 1004 according to an embodiment. The call center representative (CCR) device may also display the synchronized displays. The example flow diagram 1000 shows communications among the user device, a synchronized display server 1003 (SDS, e.g., the synchronized display server 800, FIG. 8), an interactive display server 1002 (e.g., the IDS described herein above with respect to FIG. 1), a contact center service (CCS) 1004, and a co-sharing room (Room) 1005. The SDS 1003 may send data such as, but not limited to, synchronized displays, to a CCR device. To this end, the SDS 1003 may be communicatively connected to at least one CCR device, either directly or, e.g., via a second interactive display server (not shown). The contact center service may provide data such as, but not limited to, user data.

At S1010, a data session between the user device 1001 and the interactive display server 1002 is established. The data session may be established in response to, e.g., launching of an application (e.g., the synchronized data application 125, FIG. 1), one or more inputs via the user device (e.g., selecting a “Start a Contact Center Session” or a “Connect to an Agent” button via an application on the user device), and the like.

At S1020, a data session is established between the interactive display server 1002 and the synchronized display server 1003, thereby indirectly establishing a connection between the user device 1001 and the synchronized display server 1003. At S1030, a synchronized display is sent from the synchronized display server 1003 to the interactive display server 1002. The synchronized display may include a link referencing the co-sharing room 1005 that may be, e.g., embedded in the synchronized display.

At S1040, the synchronized display is sent from the interactive display server 1002 to the user device 1001. In another implementation, the user device 1001 may retrieve the synchronized display from the interactive display server 1002. At S1050, the user device displays the synchronized display obtained at S1040.

At S1060, the interactive display server 1002 establishes a connection with the contact center service 1004 to retrieve user information. The user information may be, e.g., inserted into the co-sharing form 1005 to be utilized by the co-sharing room 1005. The user information may include the name, account number, or other information identifying the user. The user information further includes personal information related to the data to be displayed. For example, a bank account balance, demographic information to be filled in a form, and so on. At S1070, the interactive display server 1002 sends the co-sharing form to the co-sharing room 1005.

At S1080, the synchronized display server 1003 causes a display of the synchronized display on the contact center representative device (not shown). To this end, the synchronized display server 1003 may send, via a second interactive display server (not shown), the synchronized display to the contact center representative device.

At S1090-1 and S1090-2, the synchronized display server 1003 and the user device 1001, respectively, establish a connection to the co-sharing room 1005. The connections may be established based on, e.g., the link embedded in the synchronized display. It should be noted that S1090-1 and S1090-2 are illustrated in a particular order merely for simplicity purposes and without limitation on the disclosed embodiments. The connections with the co-sharing room may be established in any order or in parallel without departing from the scope of the disclosure.

Once the user device 1001 and the synchronized display server 1003 are both connected to the co-sharing room, a co-sharing session is started. During the co-sharing session, changes to the synchronized display due to user feedback (e.g., based on user interactions with the synchronized display), are also provided to the synchronized display server 1003, which causes a display of the updated synchronized display on a contact center representative device of a contact center representative supervising the co-sharing session.

It should be noted that various embodiments described herein are discussed with respect to contact center communications such as telephone calls merely for simplicity purposes and without limitations on the disclosed embodiments. Different types of communications with any entity or service involving live interactions with customer service representatives may be equally utilized, and such communications are not limited to telephone calls with call centers. For example, video or text-based chat communications may be utilized by contact centers instead of or in addition to telephone communications without departing from the scope of the disclosure.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A synchronized display server, comprising:
a processing circuity; and
a memory communicatively connected to the processing circuitry, the memory containing instructions that, when executed by the processing circuity, configure the synchronized display server to:
establish a first data session with a user device and a second data session with a contact center representative device;
obtain, from the contact center representative device, display data to be displayed on the user device, wherein the display data is communicated over the second data session;
obtain, from the user device, communication data related to communications between the user device and a contact center associated with the contact center representative device, wherein the display data is communicated over the first data session;
generate, based on the obtained display data and communication data, a synchronized display; and
send, via the first data session and the second data session, the synchronized data to the user device and to the contact center representative device, respectively, wherein each of the user device and the contact center representative device displays the sent synchronized display.

2. The synchronized display server of claim 1, wherein the synchronized display server is further configured to:
obtain feedback data from the user device;
update the synchronized display based on the obtained feedback data; and
cause a display of the updated synchronized display on the user device and on the contact center representative device.

3. The synchronized display server of claim 1, wherein the first data session is established in response to a request from a synchronized display agent installed on the user device.

4. The synchronized display server of claim 1, wherein each of the first data session and the second data session is bidirectional.

5. The synchronized display server of claim 1, wherein each of the first data session and the second data session is established via an interactive display server.

6. The synchronized display server of claim 1, wherein the synchronized display includes a form, wherein the synchronized display server is further configured to:
generate, based on personal data of a user of the user device, the form.

7. The synchronized display server of claim 1, wherein the first data session is established in response to a request from the contact center representative device.

8. The synchronized display server of claim 1, wherein the generated synchronized display includes a link to a co-sharing room, wherein the user device connects to the co-sharing room when the synchronized display is displayed on the user device, wherein the contact center representative device connects to the co-sharing room when the synchronized display is displayed on the contact center representative device.

9. The synchronized display server of claim 8, wherein the link is embedded in the generated synchronized display.

10. A non-transitory computer readable medium having stored thereon instructions for causing one or more processing units to execute a method, the method comprising:
establishing a first data session with a user device and a second data session with a contact center representative device;
obtaining, from the contact center representative device, display data to be displayed on the user device, wherein the display data is communicated over the second data session;
obtaining, from the user device, communication data related to communications between the user device and a contact center associated with the contact center representative device, wherein the display data is communicated over the first data session;
generating, based on the obtained display data and communication data, a synchronized display; and
sending, via the first data session and the second data session, the synchronized data to the user device and to the contact center representative device, respectively, wherein each of the user device and the contact center representative device displays the sent synchronized display.

11. A method for providing synchronized displays, comprising:
establishing a first data session with a user device and a second data session with a contact center representative device;
obtaining, from the contact center representative device, display data to be displayed on the user device, wherein the display data is communicated over the second data session;
obtaining, from the user device, communication data related to communications between the user device and a contact center associated with the contact center representative device, wherein the display data is communicated over the first data session;
generating, based on the obtained display data and communication data, a synchronized display; and
sending, via the first data session and the second data session, the synchronized data to the user device and to the contact center representative device, respectively, wherein each of the user device and the contact center representative device displays the sent synchronized display.

12. The method of claim 11, further comprising:
obtaining feedback data from the user device;
updating the synchronized display based on the obtained feedback data; and
causing a display of the updated synchronized display on the user device and on the contact center representative device.

13. The method of claim 11, wherein the first data session is established in response to a request from a synchronized display agent installed on the user device.

14. The method of claim 11, wherein each of the first data session and the second data session is bidirectional.

15. The method of claim 11, wherein each of the first data session and the second data session is established via an interactive display server.

16. The method of claim 11, wherein the synchronized display includes a form, further comprising:
generating, based on personal data of a user of the user device, the form.

17. The method of claim 11, wherein the first data session is established in response to a request from the contact center representative device.

18. The method of claim 11, wherein the generated synchronized display includes a link to a co-sharing room, wherein the user device connects to the co-sharing room when the synchronized display is displayed on the user device, wherein the contact center representative device connects to the co-sharing room when the synchronized display is displayed on the contact center representative device.

19. The method of claim 18, wherein the link is embedded in the generated synchronized display.
